(19) United States
(12) Patent Application Publication
(10) Pub. No.: US 2014/0283693 A1
(43) Pub. Date: Sep. 25, 2014

(54) Electrical Food Preparation Device Comprising a Pressing Screw

(71) Applicant: SEB S.A., Ecully (FR)

(72) Inventors: Christian Raude, Buros (FR); Clemence Sentagnes, Tarbes (FR)

(21) Appl. No.: 14/357,909

(22) PCT Filed: Oct. 30, 2012
(86) PCT No.: PCT/FR2012/052521

§ 371 Date: May 13, 2014

(30) Foreign Application Priority Data
Nov. 14, 2011 (FR) 1160342

(51) Int. Cl. A23N 1/02

(52) U.S. Cl. CPC A23N 1/02
USPC 99/513

(57) ABSTRACT

Provided is an electrical food preparation device comprising a unit housing a motor and supporting a work chamber comprising a cover, said work chamber containing a moveable filter locked against rotation on the unit, a pressing head driven into rotation by the motor which is arranged in a moveable manner in the filter, the pressing head comprising a pressing screw. The filter comprises load-bearing means arranged to bear the load applied to the cover by the pressing head.

The present invention relates in general to devices for making juice from fruits and/or vegetables. In particular, the invention relates to a food preparation device comprising a pressing screw arranged in a work chamber and driven in rotation by a motor arranged in an adjacent housing unit.

Juice extractors are known to the prior art.

Document WO 2007148872 discloses a pressing device comprising a motor housing unit with a work chamber coupled to the housing unit. The work chamber is composed specifically of a work vessel, which is closed during use by a cover comprising an in-feed chute. The food is pressed by a pressing screw arranged in a filter, which is positioned and fix-mounted in the work vessel. This system, however, has the disadvantage of being complicated to operate. Indeed, for hygiene reasons, all of the components housed in the work chamber are detachable for cleaning. This results in a complex assembly process for the user prior to each use. Due to the loads exerted during the pressing, all of the components must be positioned relative to one another because the filter must be kept in rotation relative to the pressing screw. The pressing screw must also be kept in the same axis as the filter. This results in a tedious process of positioning each element in relation to the other such that they align and snap into place during assembly. Lastly, all of the loads exerted on the filter or on the cover during pressing are transferred via the vessel or the cover to the work chamber, hence provision must be made of materials or thicknesses capable of withstanding these loads. This results in a substantial manufacturing cost.

Document CN101849762 proposes manufacturing a device of the aforementioned type comprising a work chamber having a two-part work vessel. This embodiment increases the number of components such that the manufacturing cost is negatively impacted, and the user must still position and fasten the load-bearing part in relation to the housing unit, and then position, index, and fasten the filter in relation to the load-bearing part. Readying this device for operation is thus a tedious process for the user, and is necessary before each use.

An object of the present invention is to address the disadvantages of the prior art documents mentioned above and in particular, firstly to propose a pressing device with a screw which is easily readied for operation and which has simple and inexpensive components for forming the work chamber.

This object is achieved with an electrical food preparation device comprising a housing unit which houses a motor and supports a work chamber comprising a cover, the work chamber containing a moveable filter locked against rotation on the unit, a pressing head driven in rotation by the motor, which is arranged in a moveable manner in the filter, the pressing head comprising a pressing screw, the filter having an opening for inserting the pressing screw, the opening being arranged opposite the cover, wherein the cover and the filter are assembled and fastened together to form a filtration chamber containing the pressing head. The loads exerted on the cover by the pressing screw are borne by the filter, which is locked against rotation on the unit. The work chamber can be formed with thinner or less expensive materials.

Advantageously then, the cover is mounted directly on the filter. An especially simple construction is thus obtainable.

To this end, a first aspect of the invention relates to an electrical food preparation device comprising a housing unit which houses a motor and supports a work chamber comprising a cover, the work chamber containing a moveable filter locked against rotation on the unit, a pressing head driven in rotation by the motor, which is arranged in a moveable manner in the filter, the pressing head comprising a pressing screw, wherein the filter comprises load-bearing means arranged to bear loads applied to the cover by the pressing head. The device of the present invention allows the simplification of the components of the work chamber because the loads applied by the cover are borne by the filter, which is locked against rotation on the unit, rather than by the work chamber. Thinner or less expensive materials can be used for forming the work chamber.

A particularly interesting embodiment consists in the fact that the load-bearing means consist of direct fastening and direct mounting of the cover on the filter. A mounting of the cover directly on the filter simplifies the design. It should also be noted that the operation is also simplified for the user because the filter, which is locked against rotation on the unit, serves as a guide for mounting the cover.

Advantageously, the filter is fastened and mounted directly on the unit for holding the filter in position in the work chamber. This embodiment allows the simplification of the work chamber because the filter is in direct contact with the unit in order to be mounted and fastened thereon. This also makes assembly easier for the user because the filter serves as a unique guide for mounting the cover.

Another embodiment of the invention relates to an electrical food preparation device comprising a unit which houses a motor and supports a work chamber containing a moveable filter, a pressing head driven in rotation by the motor being arranged in a moveable manner in the filter, the pressing head comprising a pressing screw, the work chamber being closed by a cover, wherein the filter is mounted and fastened directly on the unit in order to be held in position in the work chamber. With this embodiment, the loads exerted on the filter are transferred directly to the unit, thus allowing the simplification of the work chamber, which no longer has to bear these loads. The assembly of the pressing head components is improved by the present invention because the filter is mounted directly on the unit rather than on the work chamber such that there is no need to position the filter in relation to the work chamber. The user only uses the unit as a unique mounting guide for the filter, which eliminates the tedious operations of positioning the components in relation to one another.

Advantageously, the work chamber comprises a work vessel and the cover is mounted and fastened directly on the work vessel in order to be kept in the closed position on the work vessel, which is held in place on the unit by the filter. The invention advantageously makes use of the positioning of the filter on the unit in such a way that the filter serves as a means of holding the work vessel in place on the unit. The present invention uses the initially highly resistant structure (for resisting the pressing loads) of the filter in order to hold the work vessel (which supports the cover) in place.

More particularly, the filter has an opening for positioning the pressing head, the opening being arranged opposite the cover.

The work chamber is advantageously set directly on the unit. The load bearing by the filter according to the invention enables this additional simplification of the pressing head, because loads are no longer exerted on the chamber by the cover.

The work chamber advantageously comprises at least one discharge outlet. This discharge outlet simplifies the use of the device.

Advantageously, the discharge outlet or at least one of the discharge outlets is arranged outside the filter. In other words, the discharge outlet or at least one of the discharge outlets is provided for collecting the portion of the food that passed through the filter. If desired, provision can be made of at least one other discharge outlet for collecting the portion of the food retained by the filter.

Advantageously, said at least one discharge outlet protrudes and the unit comprises at least one notch which houses, at least partially, said at least one discharge outlet. The discharge outlet advantageously serves for locking against rotation.

Advantageously, the work chamber comprises a lower juice receiver set on the unit and a juice deflector set on the lower juice receiver. This division of the work chamber into two components simplifies the manufacturing equipment as well as the assembly for the user, who only has to set the elements in place. This arrangement also simplifies cleaning.

Alternatively, the work chamber comprises a lower juice receiver set on the unit and a juice deflector is added onto the cover. Hence the function of the juice deflector is integrated in the cover, which makes it possible to have fewer components to manipulate.

The discharge outlet is advantageously formed between the lower juice receiver and the juice deflector. The manufacturing equipment is thus simplified because there is only an open half-pipe.

Advantageously, the filter comprises a base and a raised zone in relation to the base for attachment to the unit and the pressing screw comprises a central hollow which covers the attachment zone of the filter. This embodiment prevents any juice from leaking toward the unit.

The pressing head advantageously comprises a cutting disc arranged between the cover and the pressing screw. The efficacy of the pressing is improved by the cutting disc.

Advantageously, the device comprises a control circuit for the drive motor with a circuit breaker, and the circuit breaker is actuated by control means cooperating with the cover. Since the motor cannot run unless the cover is in the closed position, safe use is guaranteed.

The control means advantageously consist of a rod arranged on the filter or on the work chamber. This embodiment is economical.

The mounting of the filter on the unit is advantageously a quarter-turn mounting system with locking. This embodiment is well-adapted for ensuring good ergonomics of use.

The mounting of the cover on the filter is advantageously a quarter-turn mounting system with locking. This embodiment is well-adapted for ensuring good ergonomics of use.

The mounting of the filter on the unit is advantageously a bayonet and tab mounting system. This embodiment is economical.

The mounting of the cover on the filter is advantageously a bayonet and tab mounting system. This embodiment is economical.

Other features and advantages of the present invention will emerge more clearly upon reading the following detailed description of embodiments of the invention provided as examples, which are in no way limiting and which are illustrated in the appended drawings. Shown are:

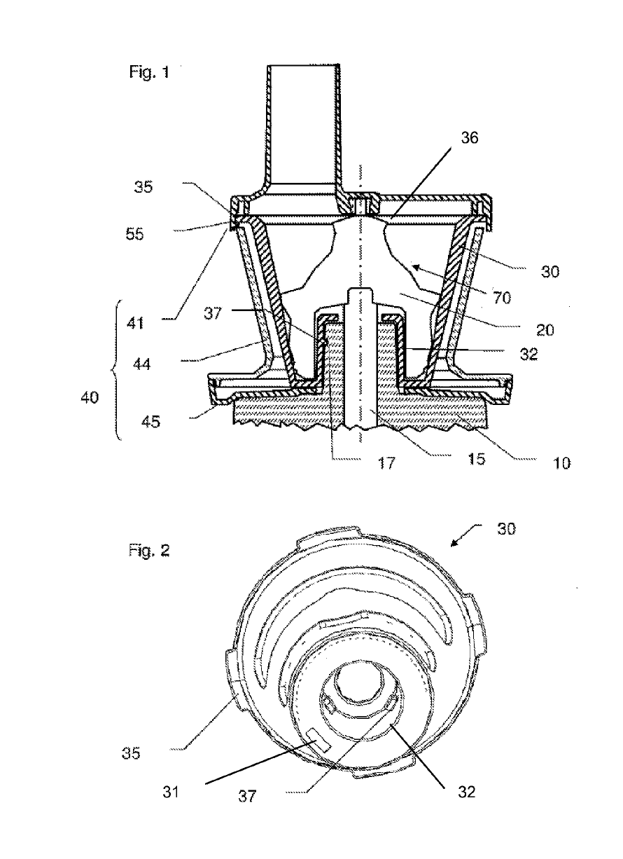

FIG. 1 illustrates a cutaway view of the device of the invention;

FIG. 2 illustrates the filter of the device of FIG. 1;

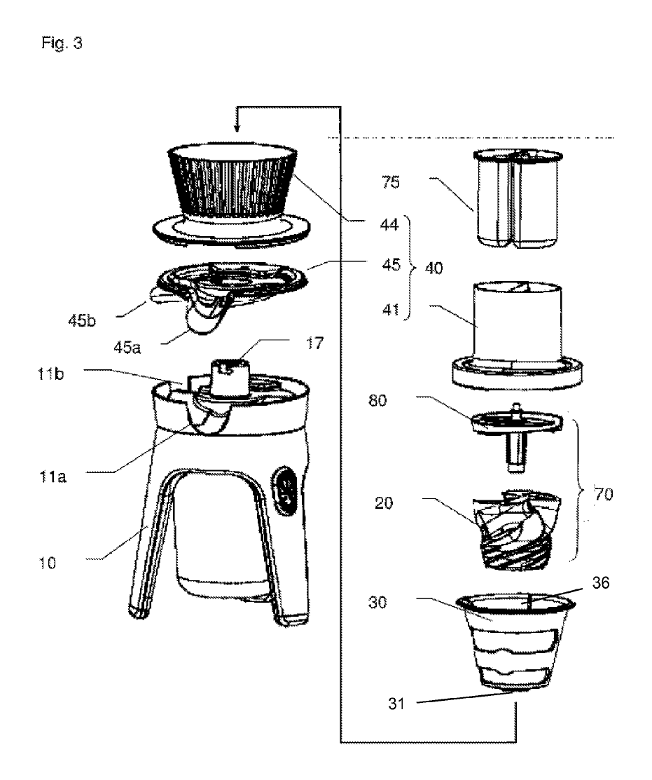

FIG. 3 illustrates another embodiment of the invention;

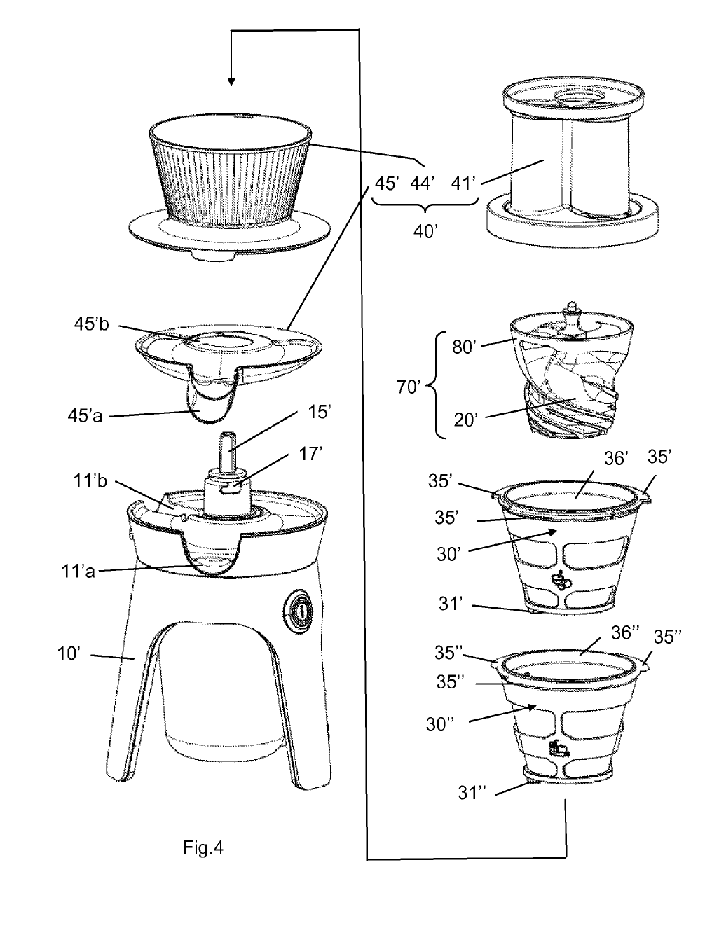

FIG. 4 illustrates a variant of embodiment;

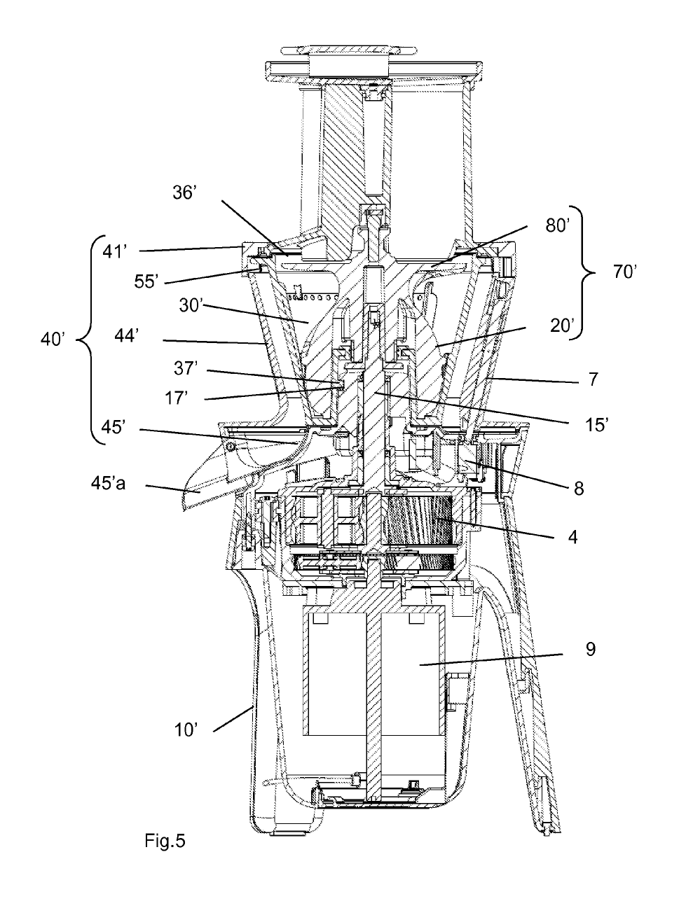

FIG. 5 is a cutaway view of the variant of embodiment illustrated in FIG. 4;

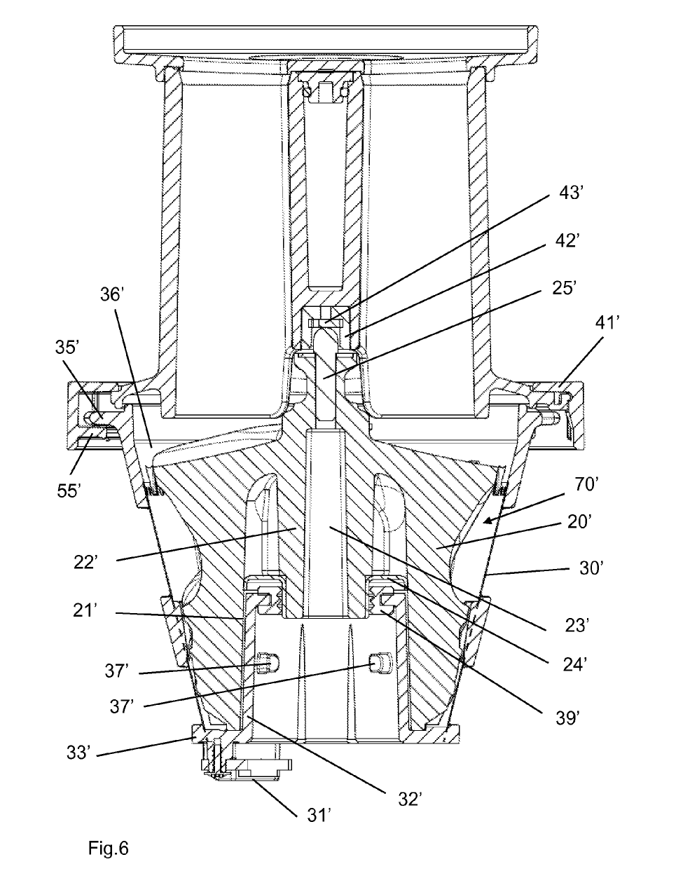

FIG. 6 is a cutaway view of a filtration chamber of the variant of embodiment illustrated in FIGS. 4 and 5;

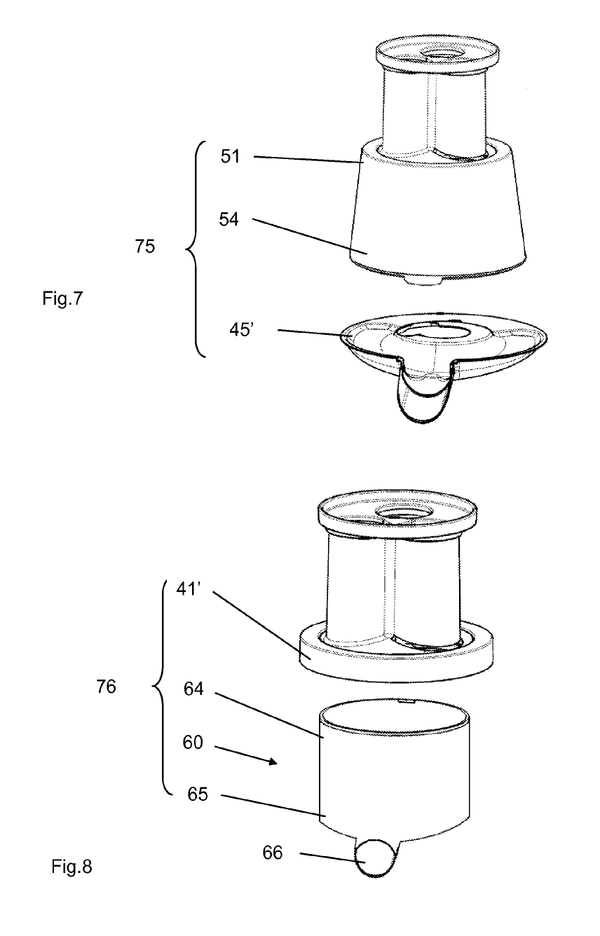

FIGS. 7 and 8 are two other exemplary embodiments of a work chamber of a device according to the invention.

FIG. 1 illustrates a food preparation device of the invention. A unit 10 houses a motor (not shown), which drives a rotary axle 15 extending from the unit 10. The unit 10 supports a work chamber 40. The work chamber 40 contains a truncated cone-shaped filter 30 and a pressing head 70. The work chamber 40 has at least one discharge outlet, which is not shown in FIG. 1.

According to an embodiment of the invention, the filter 30 is mounted and fastened directly on the unit 10 in order to be held in position in the work chamber 40. In the exemplary embodiments illustrated in the figures, the filter 30 is mounted directly on the unit 10 by means of primary tabs 37 cooperating with depressions 17 on the unit 10. These primary tabs 37 enable the user to assemble the filter 30 and the unit 10 easily and lock them in the assembled position in the manner of a bayonet-type connection with a quarter turn such that the filter 30 is integrated with the unit 10 and capable of correctly transferring the loads applied during pressing to the unit 10. Indeed, a pressing screw 20 arranged in the work chamber 40 and driven by the axle 15 exerts significant loads on the filter 30, but these loads are transferred directly to the unit 10 owing to the direct mounting of the filter 30 on the unit 10. Hence the filter 30 is mounted and fastened directly on the unit 10 in order to be held in position in the work chamber 40.

In the exemplary embodiments illustrated in the figures, the work chamber 40 is composed specifically of a lower juice receiver 45 on which is disposed a juice deflector 44. The invention avoids subjecting the lower juice receiver 45 and/or the juice deflector 44 to loads and these parts can therefore be simplified or constructed from materials that do not need to be resistant.

In the exemplary embodiment illustrated in FIGS. 1 and 2, the pressing head 70 comprises the pressing screw 20.

The pressing screw 20 is arranged in the moveable filter 30 locked against rotation on the unit 10. The work chamber 40 is closed by a cover 41 which comprises an in-feed chute.

According to another embodiment of the invention, the filter 30 comprises load bearing means arranged for bearing loads exerted on the cover 41 by the pressing head 70. In the exemplary embodiments illustrated in the figures, the load bearing means consist of a direct fastening and a direct mounting of the cover 41 on the filter 30. The cover 41 is mounted directly on the filter 30 by means of secondary tabs 35 of the filter 30, which cooperate with ribs 55 on the cover 41. The loads exerted on the cover 41 during use (such as the torques resulting from the action of the pressing screw 20 on the food pushed into the chute) are transmitted directly to the filter 30, which allows the simplification of the juice deflector 44 because no loads are transmitted to it. The mounting of the cover 41 on the filter 30 is of the quarter turn bayonet and tab type and confers good ergonomics of use, with a fastening of the cover 41 in the closed position.

As is readily discernible in FIG. 1, the filter 30 has an opening 36 for inserting the pressing head 70. The opening 36 is arranged opposite the cover 41. As shown in FIG. 1, the cover 41 and the filter 30 are thus assembled and fastened together in order to form a filtration chamber containing the pressing head 70.

It is conceivable to insert a control rod (not shown) in the juice deflector 44 or in the filter 30, said rod being actuated by a cam on the cover 41 and closing a safety circuit breaker when the cover 41 is in the closed and fastened position.

Lastly, the primary tabs 37 are arranged in a boss 32 of the filter 30, which is raised in relation to its base for eliminating any risk of the pressed juice leaking toward the unit 10 or the axle 15.

FIG. 2 is an isometric view from below the filter 30. The primary tabs 37 are arranged inside the boss 32, which is raised in relation to the base of the filter 30. These primary tabs 37 cooperate with grooves or depressions 17 of the unit 10 in order to effect a quarter turn mounting with locking in the final position. The secondary tabs 35 cooperate with the ribs 55 of the cover 41 in a similar manner on order to fasten and lock it in the closed position on the juice deflector 44. The filter 30 comprises a residue discharge outlet 31, which is discernible in FIG. 2.

FIG. 3 shows an exploded view of a second embodiment of the invention. A unit 10 comprising two notches 11a and 11b supports a lower juice receiver 45 comprising two discharge outlets 45a and 45b, which are inserted in the notches 11a and 11b. The juice deflector 44 is set on the lower juice receiver 45 and with the cover 41 forms the work chamber 40. The discharge outlet 45a, which is provided for dispensing juice, is arranged outside the filter 30 and with the juice deflector 44 forms a pipe in two parts for ease in cleaning. The work chamber 40 contains the truncated cone-shaped filter 30 and a pressing head 70. The pressing head 70, which is driven in rotation by the motor, comprises a pressing screw 20 and a cutting disc 80. A pusher 75 can help the user insert and push food into the chute of the cover 41. The filter 30 is mounted and fastened directly in the depressions 17 by means of a quarter turn bayonet and tab-type system such that its mounting on the unit 10 is easy and allows the simplification of the lower juice receiver 45, which is set on the unit 10. The lower juice receiver 45 is locked against rotation by the notches 11a and 11b and against translation by the filter 30 in such a way that it is held correctly in place on the unit 10. The cover 41 has a chute for inserting food. The cover 41 is mounted on the filter 30 by means of secondary tabs, which cannot be seen in FIG. 3.

As is readily discernible in FIG. 3, the filter 30 has an opening 36 for inserting the pressing head 70. The opening 36 is arranged opposite the cover 41. The cover 41 and the filter 30 are thus assembled and fastened together to form a filtration chamber containing the pressing head 70. The filter 30 comprises a residue discharge outlet 31 opening above the notch 11b.

FIGS. 4 and 5 illustrate a food preparation device according to the invention, comprising a unit 10′ supporting a work chamber 40′, which comprises a cover 41′. The work chamber 40′ contains a moveable filter 30′;30″ which is locked against rotation on the unit 10′. The work chamber 40′ is closed by the cover 41′.

The unit 10′ forms a pedestal on which the work chamber 40′ rests. The unit 10′ houses an electric motor 9, illustrated schematically. The motor 9 is connected to the axle 15′, by means of a transmission device 4 if desired.

The filter 30′;30″ is directly mounted and fastened in the depressions 17′ of the unit 10′ with a bayonet-type mounting system. The lower juice receiver 45′ is locked against rotation by the notch 11′a and against translation by the filter 30′;30″ in such a way that it is correctly held in place on the unit 10′.

The cover 41′ is mounted directly on the filter 30′;30″ by means of the secondary tabs 35′;35″ of the filter 30′;30″, which cooperate with ribs 55′ on the cover 41′. The cover 41′ is thus fastened onto the filter 30′;30″ by means of a bayonet-type mounting system.

A pressing head 70′ driven in rotation by the motor 9 is arranged in a moveable manner in the filter 30′;30″. The pressing head 70′ comprises a pressing screw 20′.

The filter 30′;30″ has an opening 36′;36″ for inserting the pressing head 70′. The opening 36′;36″ is arranged opposite the cover 41′. Hence the cover 41′ is assembled and fastened together with the filter 30′;30″ to form a filtration chamber containing the pressing head 70′. The filter 30′;30″ comprises a residue discharge outlet 31′;31″ opening above the notch 11b of the unit 10′.

The pressing head 70′ positioned in the work chamber 40′ is driven in rotation by the axle 15.

The device illustrated in FIGS. 4 and 5 differs from the device illustrated in FIG. 3 in that the pressing head 70′ driven in rotation by the motor 9 comprises an integrated pressing screw 20′ and an integrated cutting disc 80′. In other words, the pressing screw 20′ and the cutting disc 80′ are part of the same rotary tool.

The device illustrated in FIGS. 4 and 5 comprises a control circuit for the drive motor 9 with a circuit breaker 8 arranged in the unit 10′. The circuit breaker 8 is actuated by control means cooperating with the cover 41′. In the exemplary embodiment illustrated in FIG. 5, the control means consist of a rod 7 arranged on the work chamber 40′, more particularly in the wall of the juice deflector 44′. The rod 7 actuates the circuit breaker 8, which is formed by a switch controlling the power supply to the motor 9, which drives the rotary axle 15 when the cover 41′ is correctly fastened. Alternatively, the rod 7 could be arranged specifically in a side wall of the filter 30;30′.

FIG. 6 illustrates the filtration chamber, which is formed by the cover 41′ assembled and fastened together with the filter 30′ and contains the pressing head 70′. The ribs 55′ of the cover 41′ and the secondary tabs 35′ of the filter 30′ are connected together by means of a bayonet. The pressing screw 20′ is positioned in the filter 30′. The pressing screw 20′ has a lower axial cavity 21′ which caps the boss 32′ of the filter 30. The residue discharge outlet 31′ is arranged between the boss 32′ and the side wall 33′ of the filter 30′. The primary tabs 37′ of the filter 30′ are arranged inside the boss 32′. A ring seal 38′ is installed in a top opening of the boss 32′. The pressing screw 20′ has a hub 22′ positioned in the lower axial cavity 21′. The hub 22′ has a drive member 23′ provided in order to be driven in rotation by the axle 15′ of the unit 10′. A ring-shaped part 24′ arranged in the lower axial cavity 21′ around the hub 22′ is inserted in the inside opening of the ring seal 38′ when the pressing screw 20′ is in position in the filter 20′. The pressing screw 20′ comprises an axial guide member 25′ mounted in a bearing 42′ of the cover 41′. More particularly, the axial guide member 25′ bears against a bearing surface 43′ arranged in the bottom of the bearing 42′. The axial guide member 25′ and the bearing surface 43′ are advantageously metal and made, for example, of stainless steel.

Alternatively, the work chamber 40;40′ does not have to comprise a juice deflector 44;44′ that is separate from the lower juice receiver 45;45′ and the cover 41;41′. Specifically, the juice deflector 44;44′ can be added onto the cover 41;41′ or even connected to the lower juice receiver 45;45′ for forming a work vessel.

FIG. 7 illustrates a cover 51 incorporating a juice deflector 54. The cover 51 can be used with the lower juice receiver 45;45′ to form a work chamber 75 housing one of the filters 30;30′;30″. The filter 30;30′;30″ is then fastened to the cover 51. The juice deflector 54 is set on the lower juice receiver 45;45′.

FIG. 8 illustrates a work chamber 60 incorporating a juice deflector 64 and a lower juice receiver 65 having at least one discharge outlet 66. The work chamber 60 can be used with the cover 41;41′ to form a work chamber 76 housing one of the filters 30;30′;30″.

According to a first aspect of the invention, the filter 30;30′;30″ does not have to be mounted and fastened directly on the unit 10;10′ in order to be held in position in the work chamber 40;75. The filter 30;30′;30″ holding the pressing head 70;70′ with the cover 41;41′ can simply be locked against rotation on the unit 10;10′ without being axially retained.

According to a second aspect of the invention, the filter 30;30′;30″ does not have to comprise load-bearing means arranged for bearing the loads applied to the cover 41;41′ by the pressing head 70;70′. The work chamber 40;76 can then comprise, specifically, a work vessel 60 to which is fastened the cover 41;41′, the filter 30;30′;30″ being capable of being mounted and fastened directly on the unit 10;10′ in order to be held in position in the work chamber 40;76. If desired, the cover 41;41′ is mounted and fastened directly on the work vessel 60 in order to be held in the closed position on the work chamber 40;76, which is held in place on the unit 10;10′ by the filter 30;30′;30″.

Hence the filter 30;30′;30″ arranged in the work chamber 40;40′;75 can be fastened, or not, to the unit 10;10′ when the filter 30;30′;30″ is fastened to the cover 41;41′;51; the filter 30;30′;30″ arranged in the work chamber 40;40′;76 can be fastened, or not, to the cover 41;41′ when the filter 30;30′;30″ is fastened to the unit 10;10′.

Alternatively, the cover 41;41′;51 does not have to be mounted directly on the filter 30;30′;30″. Specifically, the cover 41;41′;51 could be fastened to the filter 30;30′;30″ by using a lock ring, with a gasket interposed if desired.

Alternatively, the pressing head 70;70′ does not have to comprise a cutting disc 80;80′.

It is understood that diverse modifications and/or improvements obvious to a person skilled in the art can be applied to the various embodiments of the invention described in this description without exceeding the scope of the invention defined by the appended claims.

In particular, reference is made to tabs for mounting the filter and the cover, but achieving this function with a nut and bolt assembly with a helical thread connection or a push-button locking mechanism is also conceivable. Lastly, interposing a cutting member between the chute and the pressing screw is conceivable.

1. Electrical food preparation device comprising a unit housing a motor and supporting a work chamber comprising a cover, the work chamber containing a moveable filter locked against rotation on the unit, a pressing head driven in rotation by the motor being arranged on a moveable manner in the filter, the pressing head comprising a pressing screw, the filter having an opening for inserting the pressing screw in the filter, the opening being arranged opposite the cover, wherein the cover is assembled and fastened together with the filter to form a filter chamber containing the pressing head.

2. Electrical device as in claim 1, wherein the cover is mounted directly on the filter.

3. Electrical food preparation device comprising a unit housing a motor and supporting a work chamber comprising a cover, the work chamber containing a moveable filter locked against rotation on the unit, a pressing head driven in rotation by the motor being arranged on a moveable manner in the filter, the pressing head comprising a pressing screw, the filter having an opening for inserting the pressing screw in the filter, the opening being arranged opposite the cover, wherein the filter comprises load-bearing means arranged for bearing loads applied to the cover by the pressing head.

4. Electrical device as in claim 3, wherein the load-bearing means consist of direct fastening and direct mounting of the cover on the filter.

5. Electrical device as in claim 1, wherein the filter is fastened and mounted directly on the unit for holding the filter in position in the work chamber.

6. Electrical food preparation device comprising a unit housing a motor and supporting a work chamber containing a moveable filter, a pressing head driven in rotation by the motor being arranged in a moveable manner in the filter, the pressing head comprising a pressing screw, the work chamber being closed by a cover, wherein the filter is mounted and fastened directly on the unit in order to be held in position in the work chamber.

7. Electrical device as in claim 6, wherein the work chamber comprises a work vessel and wherein the cover is mounted and fastened directly on the work vessel in order to be held in the closed position on the work chamber, which is held in place on the unit by the filter.

8. Electrical device as in claim 3, wherein the filter has an opening for inserting the pressing head, the opening being arranged opposite the cover.

9. Electrical device as in claim 1, wherein the work chamber is set directly on the unit.

10. Electrical device as in claim 1, wherein the work chamber comprises at least one discharge outlet.

11. Electrical device as in claim 10, wherein the or at least one of the discharge outlets is arranged outside the filter.

12. Electrical device as in claim 10, wherein said at least one discharge outlet protrudes and wherein the unit comprises at least one notch housing, at least partially, said at least one discharge outlet.

13. Electrical device as in claim 1, wherein the work chamber comprises a lower juice receiver set on the unit and a juice deflector set on the lower juice receiver.

14. Electrical device as in claim 1, wherein the work chamber comprises a lower juice receiver set on the unit and a juice deflector added onto the cover.

15. Electrical device as in claim 1, wherein the filter comprises a base and a raised zone in relation to the base for attachment to the unit, and wherein the pressing screw comprises a central hollow that covers the attachment zone of the filter.

16. Electrical device as in claim 1, wherein the pressing head comprises a cutting disc arranged between the cover and the pressing screw.

17. Electrical device as in claim 1, wherein it comprises a control circuit for the drive motor with a circuit breaker and wherein the device the circuit breaker is actuated by control means cooperating with the cover.

18. Electrical device as in claim 17, wherein the control means consist of a rod arranged on one of the filter or on the work chamber.

19. Electrical device as in claim 1, wherein the cover comprises a chute for inserting food.
